(19) United States
(12) Patent Application Publication
(10) Pub. No.: US 2018/0196190 A1
(43) Pub. Date: Jul. 12, 2018

(54) ILLUMINATION DEVICE AND DISPLAY APPARATUS

(71) Applicant: SHARP KABUSHIKI KAISHA, Sakai City, Osaka (JP)

(72) Inventor: KENJI TAKASE, Sakai City (JP)

(21) Appl. No.: 15/742,260

(22) PCT Filed: Jul. 7, 2016
(86) PCT No.: PCT/JP2016/070075

§ 371 Date: Jan. 5, 2018

(30) Foreign Application Priority Data
Jul. 13, 2015 (JP) 2015-139911

(51) Int. Cl. F21V 8/00

(52) U.S. Cl. CPC G02B 6/0091; G02B 6/0025; G02B 6/009; G02B 6/0068

(57) ABSTRACT

An illuminator (100) includes: a light guide plate (10); and an LED unit (20) disposed near a side face of the light guide plate, the LED unit including a substrate (22) and a plurality of LEDs (24) provided on the substrate. The substrate (22) has a bent or curved shape such that, past the points of bending or curving, a first face (s1) of the substrate and a second face (s2) which is continuous with the first face oppose each other at a distance. The plurality of LEDs include a plurality of first LEDs (24a) provided on the first face of the substrate and a plurality of second LEDs (24b) provided on the second face. The plurality of first LEDs (24a) and the plurality of second LEDs (24b) are disposed in two stories to emit light toward the side face of the light guide plate (10) within a space that is interposed between the first face and the second face of the substrate.

### TECHNICAL FIELD

The present invention relates to an illuminator and a display apparatus having the same.

### BACKGROUND ART

In recent years, illuminators in which LEDs (light emitting diodes) are employed as light sources have been widely used as backlight units of liquid crystal display apparatuses. Backlight units are available in the direct type, where light sources are to be provided on the rear face of a liquid crystal panel, and in the edge light type, where light sources are to be provided on an edge of the liquid crystal display apparatus. In a backlight unit of the edge light type using LEDs, near a side face of a light guide plate which is disposed on the rear face of a liquid crystal panel, a row of LEDs are arranged as light sources. Usually, the LEDs are mounted on a substrate(s), and light emission is controlled by a circuit which is formed on the substrate(s).

In a backlight unit of the edge light type, light which has been emitted from the LEDs enters into the light guide plate at a side face thereof, and travels inside the light guide plate while repeatedly undergoing total reflection at the surface of the light guide plate. In the course of this, light which travels toward the front face (i.e., the surface closer to the panel) of the light guide plate at an incident angle that is smaller than the critical angle exits from the light guide plate, toward the liquid crystal panel. On the rear face of the light guide plate, reflection dots, a prism array, etc., for allowing the entire liquid crystal panel to be uniformly irradiated with light may be provided as necessary.

### CITATION LIST

### Patent Literature

[Patent Document 1] Japanese Laid-Open Patent Publication No. 2013-84342

[Patent Document 2] Japanese Patent No. 4233941

### SUMMARY OF INVENTION

### Technical Problem

Patent Document 1 discloses a construction where, in an LED unit that is provided near a side face of a light guide plate, respective pluralities of LEDs are provided on both faces of a substrate. Patent Document 1 also describes an implementation where a plurality of LEDs are provided on each of two opposing substrates, these pluralities of LEDs being opposed to each other. In this implementation, the two substrates are connected to each other via a connector that is provided at an end of the substrate.

However, the technique described in Patent Document 1 does not provide adequate heat-releasing ability for any heat that is generated due to light emission by the LEDs. Unless the heat-releasing ability is high, the emission efficiency of the LEDs may deteriorate with temperature increase, thus resulting in the problems of increased power consumption or lowered brightness.

In the construction described in Patent Document 1, it may be possible to improve the heat-releasing ability by increasing the size of the substrate(s) on which the LEDs are mounted. However, in the above construction, increasing the size of the substrate(s) is not desirable because it creates the problem of increased size of the frame region.

The present invention has been made in view of the above problems, and an objective thereof is to provide an illuminator with improved heat-releasing ability, and a display apparatus having the same.

### Solution to Problem

An illuminator according to an embodiment of the present invention comprises: a light guide plate; and an LED unit disposed near a side face of the light guide plate, the LED unit including a substrate and a plurality of LEDs provided on the substrate, wherein, the substrate has a bent or curved shape such that, past points of bending or curving, a first face of the substrate and a second face which is continuous with the first face oppose each other at a distance; and the plurality of LEDs include a plurality of first LEDs provided on the first face of the substrate and a plurality of second LEDs provided on the second face, the plurality of first LEDs and the plurality of second LEDs being disposed in two stories to emit light toward the side face of the light guide plate within a space that is interposed between the first face and the second face of the substrate.

In one embodiment, the first face and the second face of the substrate are parallel to each other, the substrate having a third face between the first face and the second face, the third face being continuous with the first face and the second face and non-parallel to the first face and the second face.

In one embodiment, at least the third face of the substrate has been surface-treated to cause diffuse reflection of incident light.

In one embodiment, the substrate comprises a flexible substrate.

In one embodiment, the substrate comprises a metal plate.

In one embodiment, the substrate is bent in an angular U shape.

In one embodiment, the plurality of first LEDs and the plurality of second LEDs each include a red LED, a green LED, and a blue LED.

In one embodiment, the two stories of LEDs consisting of the plurality of first LEDs and the plurality of second LEDs are staggered.

In one embodiment, at least one of a pair of ends of the substrate is disposed so as to overlap an end of the light guide plate.

In one embodiment, both of the pair of ends of the substrate are disposed to overlap an end of the light guide plate, the pair of ends of the substrate sandwiching the light guide plate.

In one embodiment, the light guide plate is of a planar shape having two or more linear portions, and two or more said LED units are provided corresponding respectively to the two or more linear portions.

In one embodiment, the substrate is provided so as to leave at least a portion of the light guide plate uncovered.

One embodiment is configured to transmit external light from a rear face of the light guide plate.

A display apparatus according to an embodiment of the present invention is a see-through type display apparatus comprising the above illuminator and a transmission-type display panel which is disposed adjacent to the illuminator.

A display apparatus according to an embodiment of the present invention comprises: the above illuminator; a display panel being disposed adjacent to the illuminator; and a bezel being disposed outside of the substrate of the LED unit and having a bent or curved shape, the substrate being entirely in contact with the bezel.

### Advantageous Effects of Invention

According to an embodiment of the present invention, there is provided an illuminator with improved heat-releasing ability, and a display apparatus in which the same is used.

### BRIEF DESCRIPTION OF DRAWINGS

FIG. 1 is a diagram showing an illuminator according to Embodiment 1 of the present invention, where (a) is a plan view; (b) is a cross-sectional view along line B-B′ of (a); and (c) is a side view along line C-C′ in (a).

FIG. 2 is a diagram for illustrating production steps of an LED unit which the illuminator according to Embodiment 1 includes, where (a) is a cross-sectional view showing a state before bending; and (b) is a cross-sectional view showing a state after bending.

FIG. 3 is a diagram showing an illuminator according to Comparative Example, where (a) is a plan view; (b) is a cross-sectional view along line B-B′ in (a); and (c) is a side view along line C-C′ in (a).

FIG. 4 is a diagram showing an illuminator according to Embodiment 2 of the present invention, where (a) is a plan view; (b) is a cross-sectional view along line B-B′ in (a); and (c) is a side view along line C-C′ in (a).

FIG. 5 is a cross-sectional view for illustrating how heat radiation may occur in the illuminator according to Embodiment 2.

FIG. 6 is a graph showing improvement in LED emission efficiency based on improved heat-releasing ability.

FIG. 7 is a diagram showing an illuminator according to Embodiment 3 of the present invention, where (a) is a plan view; (b) is a cross-sectional view along line B-B′ in (a); and (c) is a side view along line C-C′ in (a).

FIG. 8, (a) is a plan view showing the construction of an LED in the illuminator according to Embodiment 1, and (b) is a plan view showing the construction of an LED in the illuminator according to Embodiment 3.

FIG. 9, (a) shows an exemplary emission spectrum of the white LED shown in FIG. 8(a), and (b) shows exemplary emission spectra when RGB emission LEDs shown in FIG. 8(b) are used.

FIG. 10 is a diagram showing an illuminator according to Embodiment 4 of the present invention, where (a) is a plan view; (b) is a cross-sectional view along line B-B′ in (a); and (c) is a side view along line C-C′ in (a).

FIG. 11 is a side view showing a staggered arrangement of two-storied LEDs in an illuminator according to Embodiment 4.

FIG. 12 is a diagram showing a difference in luminance depending on positioning, in cases (a) where two-storied LEDs are in an aligned arrangement and (b) where two-storied LEDs are in a staggered arrangement.

FIG. 13 is a diagram showing an illuminator according to Embodiment 5 of the present invention, where (a) is a plan view; (b) is a cross-sectional view along line B-B′ in (a); and (c) is a side view along line C-C′ in (a).

FIG. 14 is a diagram explaining effects of providing an improved light utilization efficiency with the illuminator according to Embodiment 5, where (a) illustrates another embodiment, and (b) illustrates Embodiment 5.

FIG. 15 is a diagram showing an illuminator according to Embodiment 6 of the present invention, where (a) is a plan view; (b) is a cross-sectional view along line B-B′ in (a); and (c) is a side view along line C-C′ in (a).

FIG. 16 is a cross-sectional view showing an illuminator according to Embodiment 7 of the present invention.

### DESCRIPTION OF EMBODIMENTS

Hereinafter, with reference to the drawings, illuminators according to embodiments of the present invention will be described. In the following description, identical or similar constituent elements are denoted by identical reference numerals. Without being limited to what is described below, an illuminator according to an embodiment of the present invention may combine more than one embodiment to be described blow, for example.

### Embodiment 1

FIGS. 1(a) to (c) show an illuminator 100 according to Embodiment 1. FIG. 1(a) corresponds to a schematic plan view of the illuminator 100; FIG. 1(b) corresponds to a cross-sectional view along line B-B′ in FIG. 1(a); and FIG. 1(c) corresponds to a side view along line C-C′ in FIG. 1(a).

As shown in FIGS. 1(a) to (c), the illuminator 100 includes a light guide plate 10 in a rectangular planar shape, and an LED unit 20 disposed near one geometric side (side face) of the light guide plate 10. Moreover, a bezel 30 serving as a frame member is provided so as to cover an end of the light guide plate 10 and the LED unit 20. As will be described later, the bezel 30 may be provided as a constituent element of the illuminator 100, or provided as a constituent element of a display apparatus that includes the illuminator 100.

In the illuminator 100, the LED unit 20 includes an elongated substrate 22 which extends along one geometric side of the light guide plate 10, with a plurality of LEDs 24 provided on the substrate 22.

As shown in FIG. 1(b), in the present embodiment, the substrate 22 has a shape that is bent at two places so as to present an angular U-shaped cross section. More specifically, the substrate 22 is bent twice at two folds that run parallel to each other, these folds being formed along the longitudinal direction of the substrate. Inside the bezel 30, which also has an angular U-shaped cross section, the substrate 22 is entirely in contact with the bezel 30. In FIG. 1(a), an upper portion of the substrate 22 and the bezel 30 are omitted from illustration.

Past the points of bending, the substrate 22 has on its inner face a first face s1 and a second face s2 which oppose each other at a distance. The first face s1 and the second face s2 are typically parallel.

As shown in FIGS. 1(b) and (c), a first LED group 24A and a second LED group 24B are respectively disposed on the first face s1 and the second face s2 of the substrate 22. The first LED group 24A and the second LED group 24B are opposed to each other within a space that is interposed between the first face s1 and the second face s2 of the substrate 22. The first LED group 24A and the second LED group 24B may be in contact, or slightly spaced apart.

In this construction, two stories of LED groups are provided as the first LED group 24A and the second LED group 24B. The two stories of LED groups 24A and 24B present a story construction, in a direction that is orthogonal to the first face s1 and the second face s2 (which may be referred to as the height direction).

The first LED group 24A is composed of a plurality of first LEDs 24a. The plurality of first LEDs 24a are arranged at intervals on the first face s1 of the substrate 22, along one geometric side (i.e., the longitudinal direction of the substrate 22) of the light guide plate 10. The second LED group 24B is composed of a plurality of second LEDs 24b. The plurality of second LEDs 24b are arranged at intervals on the second face s2 of the substrate 22, along one geometric side of the light guide plate 10. The first LEDs 24a and the second LEDs 24b may be arranged adjacent to one another, without any interspaces.

The first LEDs 24a and the second LEDs 24b are white LEDs. A white LED for use in the present embodiment may include an element which emits blue light (e.g., a blue light-emitting diode) and a fluorescent material that is excited by the blue light to emit yellow fluorescent light.

As described above, the substrate 22 is bent in an angular U shape, and the first face s1 and the second face s2, which belong in one face (inner face) of the substrate 22, are continuous with a third face s3 that exists therebetween. Thus, the first face s1 and the second face s2 (and the third face s3) are continuous faces. In the present specification, it is meant that continuous faces of a bent or curved substrate belong in one (i.e., the same face) of the front and rear faces of the substrate.

In the present embodiment, the aforementioned third face s3 is orthogonal to the first face s1 and the second face s2. However, depending on the manner of bending (or the shape of the bezel 30), the third face s3 may be a face that constitutes angles from 60° to 120°, for example, with the first face s1 and the second face s2. Unlike in the implementation shown in FIGS. 1(a) to (c), in an implementation in which the substrate is not bent but rather curved to present a cross-sectional shape in the “U” shape, the third face s3 may be a curved surface which is substantially orthogonal to the first face s1 and the second face s2 (i.e., a curved surface such that an imaginary plane connecting between ends of the curved surface is orthogonal to the first face s1 and the second face s2). Alternatively, the third face s3 may be a curved surface which substantially constitutes angles from 60° to 120° (i.e., a curved surface such that the aforementioned imaginary plane intersects the first face s1 and the second face s2 at angles from 60° to 120°). The third face s3 may be any face that opposes a side face of the light guide plate 22 (i.e., a face having an expanse in the height direction).

In the present embodiment, an FPC (Flexible Printed Circuits) is used as the substrate 22. Since an FPC is flexible, it can easily assume a shape that is bent in accordance with the shape of the bezel 30, as will be described later. The FPC has a thickness of e.g. 0.1 mm to 2.0 mm, and polyimide may be used as a base material, for example. For improved thermal conductivity, a metal layer (e.g., a copper foil) may be formed in a portion or a whole of the rear face (i.e., a face that comes in contact with the bezel 30) of the FPC.

Each of the aforementioned first and second LEDs 24a and 24b is a side-view type LED. Each of the LEDs 24a and 24b that are disposed in two stories is adapted so that its face that is orthogonal to the mounting surface of the substrate defines a light-emitting plane. As a result, the LEDs 24a and 24b are able to efficiently emit light toward the side face of the light guide plate 10.

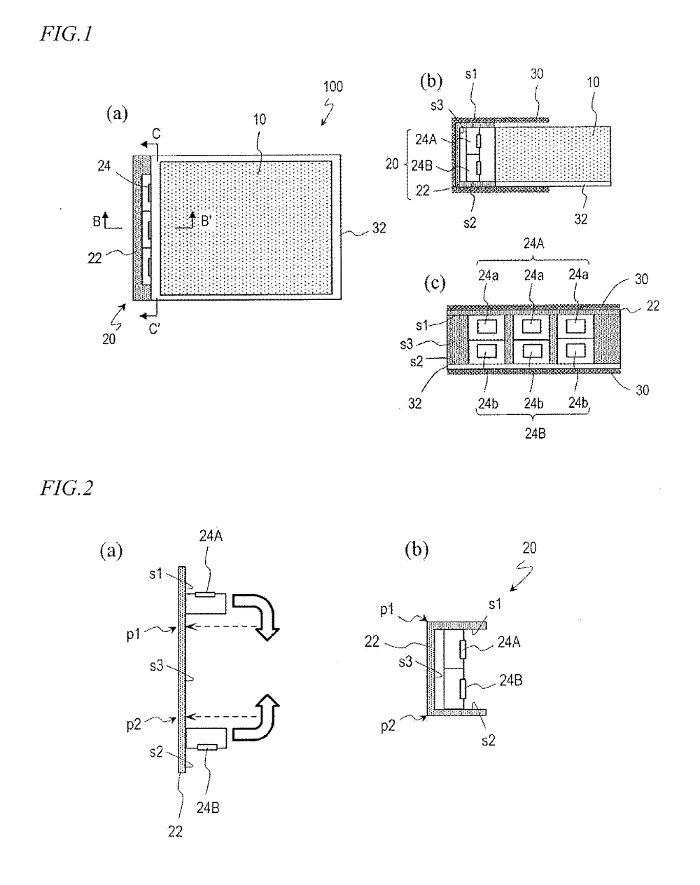

FIGS. 2(a) and (b) are diagrams for illustrating production steps of the LED unit 20. As shown in FIG. 2(a), first, on the same face of the plate-like substrate 22 prior to a bending process, the first LED group 24A and the second LED group 24B are mounted so as to be spaced apart. The first LED group 24A is mounted on the first face s1 near one end of the substrate 22, whereas the second LED group 24B is mounted on the second face s2 near another end of the substrate 22. The third face s3 exists between the first face s1 and the second face s2, the third face s3 being a face not having the first and second LED groups 24A and 24B mounted thereon.

After mounting the first LED group 24A and the second LED group 24B on the substrate 22, a white resist (e.g., an insulative protection film with a thickness of 0.01 μm) may be provided so as to cover the mounting surface of the substrate 22. Providing a white resist can confer an improved diffuse-reflective property on the substrate surface. On the mounting surface of the substrate 22, a reflection sheet that is capable of causing diffuse reflection may be provided.

Thereafter, at two places p1 and p2 of the substrate 22 as shown in FIG. 2(a), the substrate 22 is bent so that the faces having the first and second LED groups 24A and 24B mounted thereon are oriented inward. As a result, as shown in FIG. 2(b), the substrate 22 having an angular U-shaped cross section is obtained, such that the first LED group 24A and the second LED group 24B abut with each other. In this step, the two places p1 and p2 at which to bend the substrate 22 are both positioned between the first LED group 24A and the second LED group 24B, which are spaced apart at mounting. Moreover, the substrate surface existing between the two places p1 and p2 to be bent corresponds to the third face s3.

As described earlier, the bezel (frame member) 30 is provided on the outside of the LED unit 20. The bezel 30 may be provided as a constituent element of the illuminator 100, or as a member in a liquid crystal display apparatus that includes the illuminator 100, in a manner of connecting between the liquid crystal panel (not shown) and the illuminator 100, for example.

The bezel 30 may be formed through a bending process of a metal piece of plate material having e.g. a thickness 0.5 mm to 1.0 mm (Al, Fe, or an alloy thereof (e.g., SUS)). The bezel 30 may have a thermal conductivity of e.g. 50 W/(m·k) to 500 W/(m·k). The material of the bezel 30 may be appropriately selected so as to reconcile rigidity and heat-releasing ability, and suitably has a thermal conductivity which is equal to or greater than the thermal conductivity of the substrate 22.

In the present embodiment, the bezel 30 and the substrate 22 having the LEDs mounted thereon are in contact for most part of their faces. It is ensured that the entire outer face of the substrate 22, which is bent as aforementioned, is directly in contact with the bezel 30. However, without being directly connected, the bezel 30 and the substrate 22 may be coupled and fixed to a high level of adhesion via e.g. a tacky sheet, a paste substance, or the like that has good thermal conductivity, this being in order to provide improved thermal conductivity.

In the aforementioned illuminator 100, the light guide plate 10 may be of various known implementations. For example, the light guide plate 10 may be made of a light-transmissive resin material such as an acrylic plate, with a thickness on the order of 0.3 mm to 10 mm, for example. In the present embodiment, as shown in FIGS. 1(a) to (c), a reflection sheet 32 is provided on the rear face side of the light guide plate 10. Providing the reflection sheet 32 prevents light from the LEDs 24 from exiting from the rear face of the light guide plate 10, thus enhancing the light utilization efficiency of the illuminator.

Without being limited to an implementation where the reflection sheet 32 is provided, reflection dots or a prism array may be provided on the rear face of the light guide plate 10. The rear face of the light guide plate 10 may be a face that is inclined with respect to the front face (i.e., the surface closer to the panel: light-outgoing surface).

Although not shown in FIGS. 1(a) to (c), a liquid crystal display panel may be disposed in front of the illuminator 100, so that a liquid crystal display apparatus is constructed from the liquid crystal display panel and the illuminator 100. As the liquid crystal display panel, a transmission-type liquid crystal display panel of any of various known implementations can be used. As the display mode, a vertical field mode such as VA (Vertical Alignment) or TN (Twisted Nematic), a lateral field mode such as IPS (In-plane Switching) or FFS (Fringe Field Switching), or the like may be arbitrarily selected.

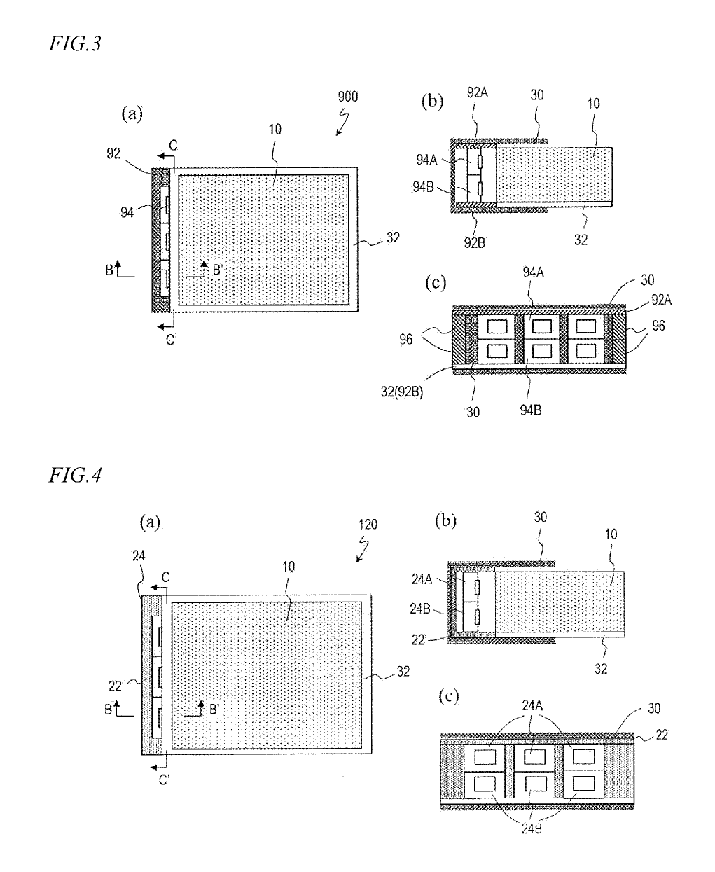

Now, with reference to FIGS. 3(a) to (c), an illuminator 900 according to Comparative Example will be described. In the illuminator 900, unlike in the illuminator 100 according to Embodiment 1 shown in FIGS. 1(a) to (c), a first LED group 94A and a second LED group 94B are respectively mounted on a pair of substrates 92A and 92B that are opposed to each other. In other words, the first LED group 94A and the second LED group 94B are mounted on different substrates 92A and 92B. In this construction, each substrate 92A, 92B is plate-like.

In this implementation, as shown in FIG. 3(c), the substrates 92A and 92B are connected to each other via connection members 96 that are provided at ends. In the illuminator 900 of Comparative Example, the substrates 92A and 92B are plate-like, thus resulting in a relatively small area of contact between the substrates 92A and 92B and the bezel 30. Therefore, adequate heat-releasing ability may not exist for the heat that has been generated from the LEDs 94. There is also the problem of an increased number of component parts because the upper and lower substrates 92A and 92B are connected by using the connection members 96.

On the other hand, in the illuminator 100 according to Embodiment 1 as shown in FIG. 1, LEDs are mounted on the same face of the same LED substrate, which is subjected to a bending process to attain an angular U shape, and all LEDs are disposed so that their light-emitting planes oppose a side face of the light guide plate. This construction allows LEDs to be mounted in an increased area on the substrate, thus ensuring a high heat-releasing ability. Especially when the bezel is made of a material with high thermal conductivity, a significantly improved heat-releasing ability can be obtained by increasing the area of contact between the bezel and the substrate. Also in the above construction, the increased geometric area of the LED substrate permits an increase in the wiring patterns. Also in the above construction, while increasing the geometric area of the LED substrate, the frame width can be kept equally narrow or even narrower. Furthermore, since only one LED substrate is being used, there is no need for connectors for providing connection between LED substrates as would be required in the illuminator 900 of Comparative Example shown in FIG. 3, whereby the number of component parts can be advantageously reduced.

In the illuminator 100 according to Embodiment 1, a white resist material or the like may be provided on the inner face of the substrate 22, thus improving the diffuse-reflective property at the surface. This allows more uniform light to be provided. In particular, by applying a surface treatment to enhance the diffuse-reflective property of the aforementioned third face s3, more diffused light is allowed to travel toward the side face of the light guide plate, thereby improving the light utilization efficiency.

Patent Document 2 describes an illuminator in which LEDs are directly mounted on an FPC that is connected to a liquid crystal panel, and which utilizes the reflective property of the FPC being curved behind the LEDs so as to improve light utilization efficiency. In this construction, the FPC is connected at an edge of the liquid crystal panel, and disposed so as to cover the rear face of the light guide plate. In the construction of Patent Document 2, however, the LEDs are mounted in one story on the FPC, which construction does not make it easy for a greater number of LEDs to be provided. Furthermore, in Patent Document 2, the FPC covers the rear face of the liquid crystal display panel in its entirety, and thus is difficult to be applied to a see-through type display apparatus as will be illustrated in Embodiment 7 below, for example.

Thus, although an implementation in which the bezel 30 and the substrate 22 have an angular U-shaped cross section has been illustrated as the illuminator 100 according to Embodiment 1, this is not a limitation; other implementations may also be possible. For example, the bezel 30 and the substrate 22 may have a U-shaped cross section while being entirely in contact with each other. Alternatively, the illuminator may be adapted so that the third face s1 of the substrate 22 (and the inner face of the bezel 30) has a convex curved surface that protrudes toward the light guide plate 10.

### Embodiment 2

FIGS. 4(a) to (c) are a plan view, a cross-sectional view, and a side view showing an illuminator 120 according to Embodiment 2. FIG. 4(b) corresponds to a cross-sectional view along line B-B′ in FIG. 4(a); and FIG. 4(c) corresponds to a side view along line C-C′ in FIG. 4(a).

The illuminator 120 according to the present embodiment differs from the illuminator 100 according to Embodiment 1 in that a metal substrate 22′ is used as the substrate on which to mount LEDs, rather than an FPC.

From the standpoint of improving the heat-releasing ability, it is preferable to use a material with high thermal conductivity as the metal substrate 22′. Table 1 below indicates thermal conductivity and characteristics of representative materials that may be used for the substrate.

TABLE 1

| | thermal | |
|---|---|---|
| | conductivity | |
| material name | [W/mK] | characteristic |
| gold | 320 | high cost |
| silver | 420 | high thermal conductivity |
| | | high reflectance |
| | | high cost |
| copper | 398 | high thermal conductivity |
| | | bending process is easy |
| aluminum | 236 | bending process is easy |
| | | low cost |
| iron material | 84 | high rigidity |
| | | low cost |

As indicated in Table 1 above, silver has high thermal conductivity, and also high reflectance. Using a material with high reflectance allows a portion of the light emitted from the LEDs to be reflected from the rear face (the third face s3 of the substrate 22) so as to be incident on the light guide plate more efficiently.

However, silver is expensive; from the standpoint of production cost, it is suitable to use an aluminum or copper plate. Moreover, an aluminum plate or a copper plate is suitable also in that they permit an easy bending process.

In the present embodiment, too, as in Embodiment 1 illustrated in FIG. 2, a first LED group and a second LED group are first mounted at intervals on a plate-like metal substrate, and then the substrate is subjected to a bending process at two places, whereby an LED unit can be produced. The bent substrate has an angular U-shaped cross section, such that the first LED group and the second LED group are disposed in two stories between the first face s1 and the second face s2.

FIG. 5 is a diagram for illustrating how heat radiation may occur in Embodiment 2. Since a plate of a metal material having high thermal conductivity is used as the substrate 22′, the heat generated from the LEDs is efficiently released to the exterior via the substrate 22′ and the bezel 30.

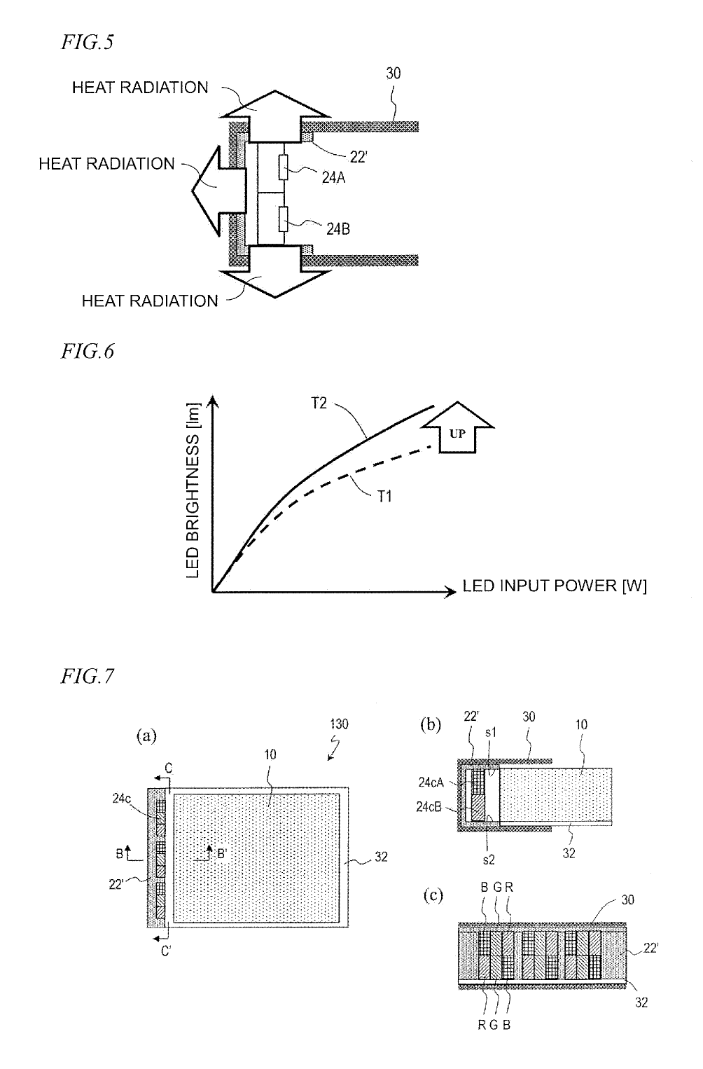

FIG. 6 shows improvement in LED emission efficiency based on improved releasability for the heat generated from the LEDs. In the broken-line graph T1, the heat-releasing ability is not adequate, and the LED brightness for the input power is relatively low (i.e., the LED emission efficiency is low). On the other hand, when the heat-releasing ability is improved as in the present embodiment, increase in the device temperature can be suppressed as indicated by the solid-line graph T2, and thus the LED emission efficiency is improved.

The illuminator 120 according to Embodiment 2 as described above has improved heat radiation characteristics, so that a higher emission efficiency is obtained for the same LED input power, whereby improvements in luminance can be expected. The improved heat radiation characteristics are expected to contribute to longer lives of the LEDs, thus keeping the failure rate low. Furthermore, by appropriately selecting a metal material, reflectance at the substrate surface can be easily enhanced, thus enabling further improvements in luminance. Furthermore, mechanical rigidity around the LED substrate can be enhanced.

### Embodiment 3

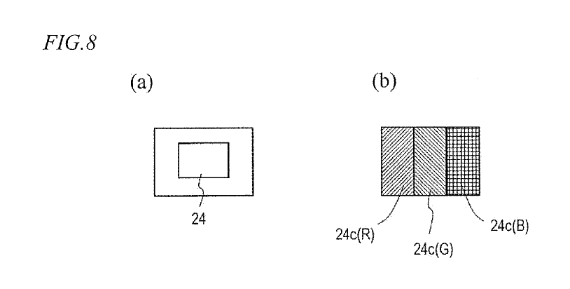

FIGS. 7(a) to (c) are a plan view, a cross-sectional view, and a side view showing an illuminator 130 according to Embodiment 3. FIG. 7(b) corresponds to a cross-sectional view along line B-B′ in FIG. 7(a); and FIG. 7(c) corresponds to a side view along line C-C′ in FIG. 7(a).

The illuminator 130 according to the present embodiment differs from the illuminator 100 or 120 according to Embodiment 1 or 2 in that color LEDs 24c are used as the LEDs. In the illuminator 130, red LEDs (R), green LEDs (G), and blue LEDs (B) which are respectively capable of emitting red light, green light, and blue light, are provided as light-emitting elements.

As shown in FIGS. 7(b) and (c), in the present embodiment, too, a first color LED group 24cA and a second color LED group 24cB are respectively provided on a first face s1 and a second face s2 of a substrate 22. Moreover, similarly to Embodiments 1 and 2, the first color LED group 24cA and the second color LED group 24cB are disposed in two stories on the substrate 22, which is bent so as to have an angular U-shaped cross section.

Moreover, each of the two stories of LED groups 24cA and 24cB includes red (R), green (G), and blue (B) LEDs. In the embodiment shown in FIGS. 7(a) and (c), sets of LEDs, each set consisting of three colors of red (R), green (G), and blue (B), are spaced apart. As shown in FIG. 7(c), the order of red (R), green (G), and blue (B) may be differentiated between the two upper and lower stories of LED groups, whereby more uniform (i.e., having less color unevenness) light can be radiated.

As the aforementioned LEDs to emit three colors of RGB, those containing RGB within one package (3-in-1 type), independent packages of R, G and B, RGB-LEDs containing a Blue chip and fluorescent materials to be excited by B light, etc., may be used as appropriate.

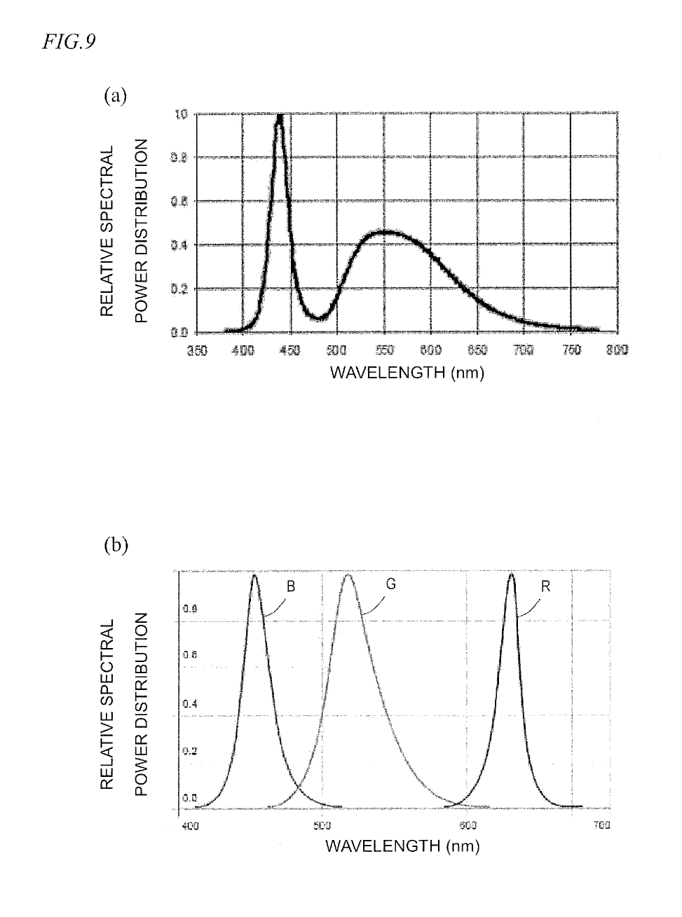

FIG. 8(a) shows a white LED 24, and FIG. 8(b) shows color LEDs 24c (red LED 24c (R), green LED 24c (G), blue LED 24c (B)). FIG. 9(a) shows a relative spectral power distribution (emission spectrum) for the aforementioned white LED 24, and FIG. 9(b) shows relative spectral power distributions with respect to the aforementioned color LEDs 24c.

As shown in FIG. 9(a), the white LED 24 has an emission spectrum which indicates a peak in the blue wavelength region, and also a gentle peak in the wavelength region of fluorescent light from the fluorescent material. On the other hand, as shown in FIG. 9(b), when color LEDs are used, their emission spectra indicate peaks in the respective wavelength regions of blue, green, and red.

By using color LEDs for the light sources as in the illuminator 130 according to the present embodiment, it becomes possible to control emission of color light of each color, thus enabling displaying with high color reproducibility. Moreover, depending on the purpose, only the LEDs of desired colors may be driven to select an emission color. For example, use of the illuminator for field sequential driving may be possible, where red light, green light, and blue light are switched for emission by time division. Field sequential driving can achieve color displaying without the need to provide color filters in the liquid crystal display panel, whereby a high light utilization efficiency is realized. When a HEMS (Micro Electro-Mechanical Systems) display is produced by using the illuminator 130 as an illuminator for field sequential driving, the need for polarizers and color filters is eliminated, thus enabling displaying with good color reproducibility while achieving a high light utilization efficiency.

The above has illustrated an example of using LEDs that emit color light in the three colors of RGB. However, this is not a limitation, and LEDs to emit other colors (e.g., C (cyan), H (magenta), Y (yellow)) may also be used. Furthermore, without being limited to three colors, LEDs of four colors (e.g., RGBW (white) or RGBY), or five or more colors may be used.

### Embodiment 4

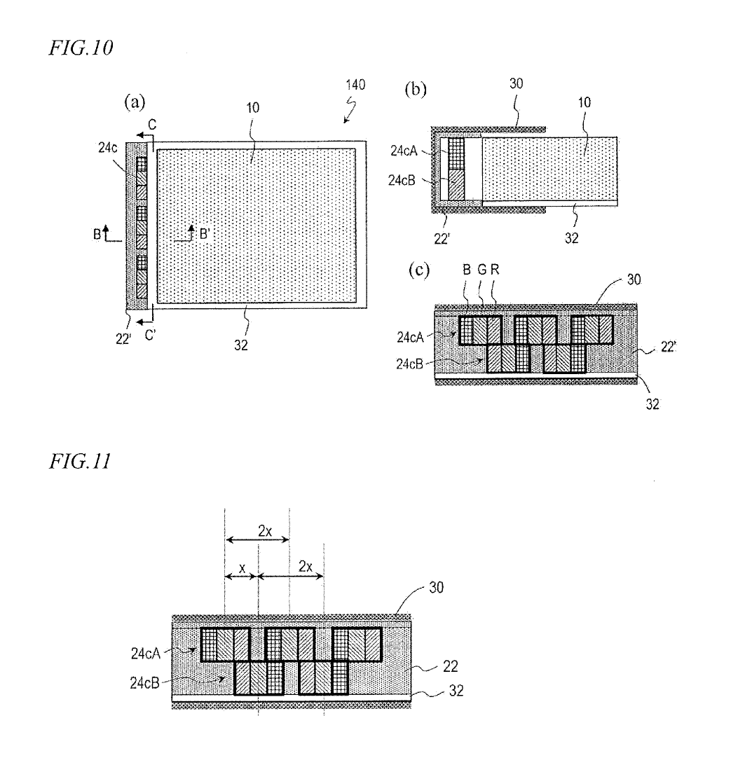

FIGS. 10(a) to (c) are a plan view, a cross-sectional view, and a side view showing an illuminator 140 according to Embodiment 4. FIG. 10(b) corresponds to a cross-sectional view along line B-B′ in FIG. 10(a); and FIG. 10(c) corresponds to a side view along line C-C′ in FIG. 10(a).

The illuminator 140 according to the present embodiment differs from the illuminator 130 according to Embodiment 3 in that two upper and lower stories of color LEDs 24c are placed in a staggered arrangement. As the light-emitting element, the illuminator 140 includes red LEDs (R), green LEDs (G), and blue LEDs (B) which are capable of emitting red light, green light, and blue light, respectively. However, the LED group 24cA in one story and the LED group 24cB in the other story are not matched in position, but rather are shifted by every half pitch along the horizontal direction (i.e., the longitudinal direction of the substrate).

FIG. 11 is a diagram for illustrating the shifted arrangements of LEDs. As shown in FIG. 11, given that the LEDs in each story are arranged at a pitch 2x, the upper and lower stories are shifted in position by a half pitch x, along the horizontal direction. In the implementation shown in FIG. 11, as a result of shifting the upper and lower stories in position by a half pitch x, each lower LED is disposed astride both two upper LEDs.

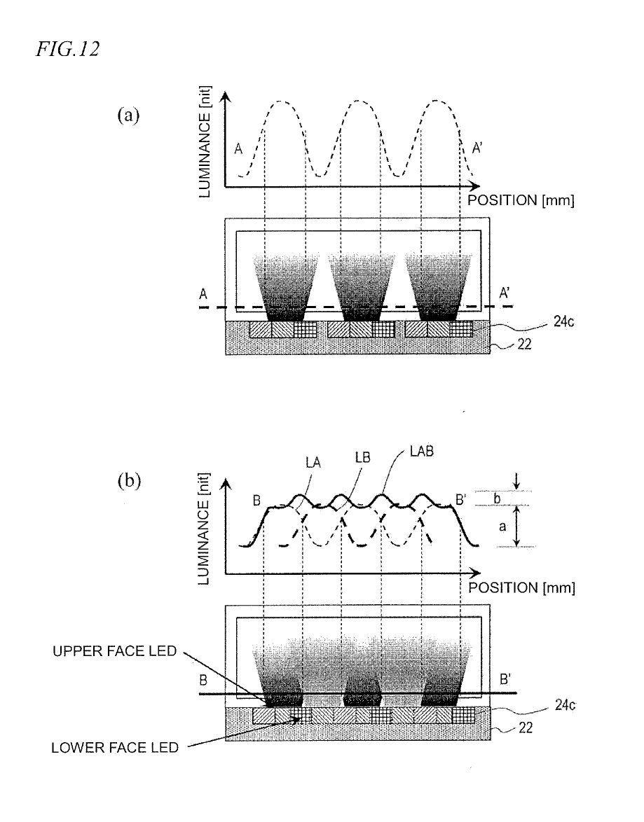

FIGS. 12(a) and (b) illustrate a difference in luminance depending on the positions of LED units along the horizontal direction, with respect to the case where two stories of LED groups are in an aligned arrangement as in Embodiment 3, and the case where they are in a staggered arrangement as in Embodiment 4. In FIGS. 12(a) and (b), arrangements of LEDs and their states of emission are shown in the lower portion, whereas the relationship between position and luminance is shown in the upper portion. Note that the upper graph corresponds to a luminance distribution at a position of line or line B-B′ in the lower portion.

As shown in FIG. 12(a), when two stories of LED groups are disposed in alignment, there is high luminance at the central position of an LED set consisting of the three colors of R, G and B, while there is low luminance at positions between adjacent LED sets, where LEDs are not present. This is likely to result in non-uniform irradiation light.

On the other hand, as shown in FIG. 12(b), when two stories of LED groups are in a staggered arrangement, a luminance distribution LA associated with the upper-story LED group and a luminance distribution LB associated with the lower-story LED group become merged, thereby giving a more uniform luminance distribution LAB. Now, a luminance difference b occurring across the entire LED emission from two stories in a staggered arrangement (i.e., the luminance distribution LAB after the aforementioned merging) is smaller than a maximum value a of luminance difference occurring in the LED emission of each story (b<a). This improves uniformness of luminance at the side face of the light guide plate.

### Embodiment 5

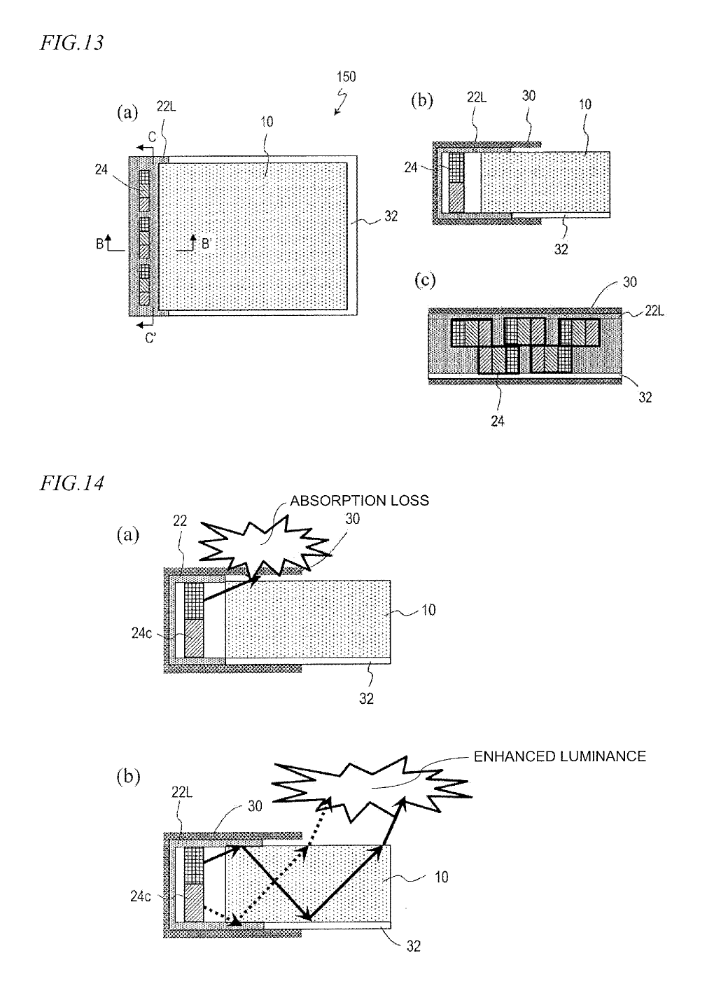

FIGS. 13(a) to (c) are a plan view, a cross-sectional view, and a side view showing an illuminator 150 according to Embodiment 5. FIG. 13(b) corresponds to a cross-sectional view along line B-B′ in FIG. 13(a); and FIG. 13(c) corresponds to a side view along line C-C′ in FIG. 13(a).

The illuminator 150 according to the present embodiment differs from the illuminator 140 according to Embodiment 4 in that a larger sized substrate 22L is used. In the illuminator 150, an end of the light guide plate 10 is covered by both ends of the substrate 22L; that is, the ends of the substrate 22L sandwich the end of the light guide plate 10.

FIGS. 14(a) and (b) are diagrams explaining advantages of the construction of the present embodiment, where FIG. 14(a) illustrates another embodiment, and FIG. 14(b) illustrates this Embodiment 5.

As can be seen from FIGS. 14(a) and (b), in this Embodiment 5, the substrate 22L is extended to positions where it covers an end of the light guide plate. As a result, absorption of light at the bezel 30 (FIG. 14(a)) is prevented, and more light becomes available for illumination by utilizing the reflective property of the substrate 22L (FIG. 14(b)). This realizes enhanced luminance.

Since light which is reflected by the substrate 22L scatters, luminance unevenness at the side face of the light guide plate 10 is reduced. In the case where color LEDs are used, which is susceptible to intermixing of colors, color unevenness can be reduced.

### Embodiment 6

FIGS. 15(a) to (c) are a plan view, a cross-sectional view, and a side view showing an illuminator 160 according to Embodiment 6. FIG. 15(b) corresponds to a cross-sectional view along line B-B′ in FIG. 15(a); and FIG. 15(c) corresponds to a side view along line C-C′ in FIG. 15(a).

The illuminator 160 according to the present embodiment differs from the illuminator 150 according to Embodiment 5 in that LED units are respectively provided at two opposing geometric sides of the light guide plate 10. The light guide plate 10 has a rectangular planar shape with two opposing geometric sides (linear portions) that are parallel to each other. Along each of these two geometric sides, LEDs of a respective LED unit form a row.

In each of these paired LED units, two stories of color LEDs 24c are disposed in a staggered arrangement, on a substrate 22L which is bent in an angular U shape. Each unit may be substantially identical in construction. However, the LED units may have respectively different constructions, and may be based on a combination of any two of Embodiments 1 to 5.

Since light sources are provided on both sides of the light guide plate 10, the illuminator 160 can realize enhanced luminance. Moreover, as compared to the case where LEDs are provided only on one side, variations in emitted light are unlikely to occur in the illuminator 160 between portions of the light guide plate 10 that are closer to the LEDs and portions that are farther from the LEDs. As a result, light which is emitted from the light guide plate can attain improved in-plane uniformity of intensity.

### Embodiment 7

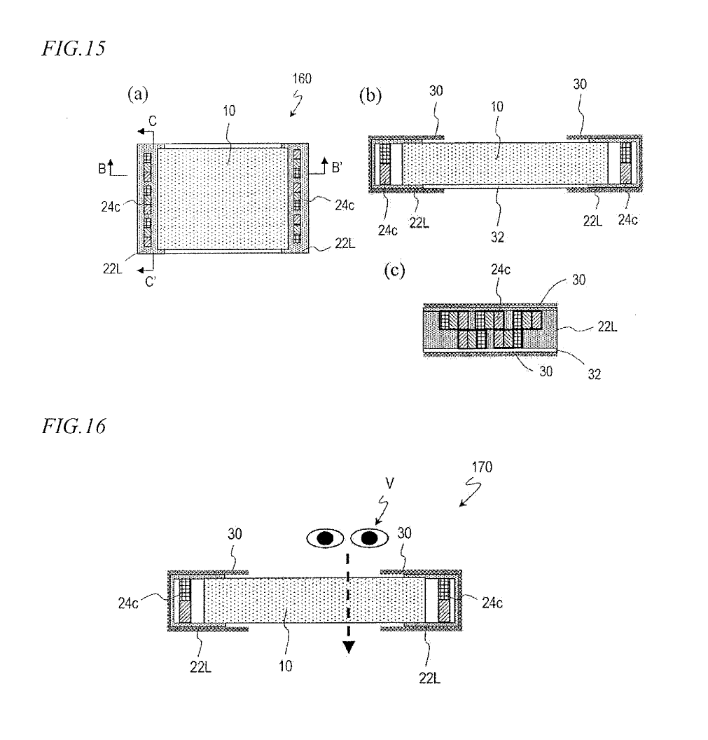

FIG. 16 is a cross-sectional view showing an illuminator 170 according to Embodiment 7.

The illuminator 170 lacks the reflection sheet 32 which was provided at the rear face of the light guide plate 10 in the illuminators of other Embodiments 1 to 6. Therefore, while the LEDs 24c are not emitting light, a viewer V is able to view the background, through the light-transmissive light guide plate 10. In other words, the illuminator 170 is adapted so as to allow light (external light) from the rear face side of the light guide plate 10 to exit through the front face of the light guide plate.

Thus, by combining the transmission-type illuminator 170 and a transmission-type liquid crystal panel, a so-called see-through type display apparatus is obtained, which can show not only a displayed image but also the background. See-through type display apparatuses are able to realize new manners of displaying which were not possible with conventional display apparatuses, and are attracting attention as display apparatuses having good appeal and eyecatchingness.

The illuminator 170 becomes transparent when the LEDs are OFF, thus providing an effect in that the obtrusive appearance of the illuminator is alleviated so as to result in less presence.

Thus, illuminators and display apparatuses according to embodiments of the present invention have been described. It will be appreciated that various modifications are possible. Applications of display apparatuses may include, for example, liquid crystal display apparatuses and MEMS displays.

The present specification discloses illuminators and display apparatuses as recited in the following Items.

[Item 1]

An illuminator comprising: a light guide plate; and an LED unit disposed near a side face of the light guide plate, the LED unit including a substrate and a plurality of LEDs provided on the substrate, wherein,

the substrate has a bent or curved shape such that, past points of bending or curving, a first face of the substrate and a second face which is continuous with the first face oppose each other at a distance; and

the plurality of LEDs include a plurality of first LEDs provided on the first face of the substrate and a plurality of second LEDs provided on the second face, the plurality of first LEDs and the plurality of second LEDs being disposed in two stories to emit light toward the side face of the light guide plate within a space that is interposed between the first face and the second face of the substrate.

With the illuminator of Item 1, the heat-releasing ability of the substrate on which LEDs are provided can be improved. Moreover, the number of component parts can be reduced.

[Item 2]

The illuminator of Item 1, wherein the first face and the second face of the substrate are parallel to each other, the substrate having a third face between the first face and the second face, the third face being continuous with the first face and the second face and non-parallel to the first face and the second face.

With the illuminator of Item 2, while appropriately disposing two stories of LEDs by using a substrate having parallel faces, the heat-releasing ability of the substrate can be improved.

[Item 3]

The illuminator of Item 2, wherein at least the third face of the substrate has been surface-treated to cause diffuse reflection of incident light.

With the illuminator of Item 3, light which has been emitted from LEDs and then diffuse-reflected from the substrate is allowed to be incident on the light guide plate, thereby enhancing the light utilization efficiency.

[Item 4]

The illuminator of any of Items 1 to 3, wherein the substrate comprises a flexible substrate.

With the illuminator of Item 4, the substrate permits an easy bending process.

[Item 5]

The illuminator of any of Items 1 to 3, wherein the substrate comprises a metal plate.

With the illuminator of Item 5, the heat-releasing ability of the substrate can be further improved.

[Item 6]

The illuminator of any of Items 1 to 5, wherein the substrate is bent in an angular U shape.

With the illuminator of Item 6, the heat-releasing ability can be improved by using a substrate which is bent in an angular U shape.

[Item 7]

The illuminator of any of Items 1 to 6, wherein the plurality of first LEDs and the plurality of second LEDs each include a red LED, a green LED, and a blue LED.

With the illuminator of Item 7, good color rendition is obtained, and the color reproducibility can be improved.

[Item 8]

The illuminator of any of Items 1 to 7, wherein the two stories of LEDs consisting of the plurality of first LEDs and the plurality of second LEDs are staggered.

With the illuminator of Item 8, more uniform light is allowed to be incident on the light guide plate, whereby luminance unevenness and color unevenness can be reduced.

[Item 9]

The illuminator of any of Items 1 to 8, wherein at least one of a pair of ends of the substrate is disposed so as to overlap an end of the light guide plate.

With the illuminator of Item 9, the light utilization efficiency can be improved by utilizing reflection at the substrate.

[Item 10]

The illuminator of Item 9, wherein both of the pair of ends of the substrate are disposed to overlap an end of the light guide plate, the pair of ends of the substrate sandwiching the light guide plate.

With the illuminator of Item 10, the light utilization efficiency can be further improved by utilizing reflection at the substrate.

[Item 11]

The illuminator of any of Items 1 to 10, wherein the light guide plate is of a planar shape having two or more linear portions, and two or more said LED units are provided corresponding respectively to the two or more linear portions.

With the illuminator of item 11, enhanced luminance can be obtained.

[Item 12]

The illuminator of any of Items 1 to 11, wherein the substrate is provided so as to leave at least a portion of the light guide plate uncovered.

With the illuminator of Item 12, an implementation is realized where the rear face or the like of the light guide plate is not covered.

[Item 13]

The illuminator of any of Items 1 to 12, configured to transmit external light from a rear face of the light guide plate.

With the illuminator of Item 13, an implementation is realized where the background can be viewed through the light guide plate.

[Item 14]

A see-through type display apparatus comprising the illuminator of Item 13 and a display panel which is disposed adjacent to the illuminator.

With the display apparatus of Item 14, the background can be displayed while the LEDs are not activated.

[Item 15]

A display apparatus comprising: the illuminator of any of Items 1 to 13; a display panel being disposed adjacent to the illuminator; and a bezel being disposed outside of the substrate of the LED unit and having a bent or curved shape, the substrate being entirely in contact with the bezel.

With the display apparatus of Item 15, heat can be dissipated to the bezel for an improved heat-releasing ability.

### INDUSTRIAL APPLICABILITY

An illuminator according to an embodiment of the present invention can be suitably used as a backlight for a liquid crystal display apparatus, for example.

### REFERENCE SIGNS LIST

10 light guide plate
20 LED unit
22 substrate
24 LED
24a first LED
24A first LED group
24b second LED
24B second LED Group
24c color LED
30 bezel
32 reflection sheet
100 illuminator
s1 first face
s2 second face
s3 third face

1. An illuminator comprising: a light guide plate; and an LED unit disposed near a side face of the light guide plate, the LED unit including a substrate and a plurality of LEDs provided on the substrate, wherein,
the substrate has a bent or curved shape such that, past points of bending or curving, a first face of the substrate and a second face which is continuous with the first face oppose each other at a distance; and
the plurality of LEDs include a plurality of first LEDs provided on the first face of the substrate and a plurality of second LEDs provided on the second face, the plurality of first LEDs and the plurality of second LEDs being disposed in two stories to emit light toward the side face of the light guide plate within a space that is interposed between the first face and the second face of the substrate.

2. The illuminator of claim 1, wherein the first face and the second face of the substrate are parallel to each other, the substrate having a third face between the first face and the second face, the third face being continuous with the first face and the second face and non-parallel to the first face and the second face.

3. The illuminator of claim 2, wherein at least the third face of the substrate has been surface-treated to cause diffuse reflection of incident light.

4. The illuminator of claim 1, wherein the substrate comprises a flexible substrate.

5. The illuminator of claim 1, wherein the substrate comprises a metal plate.

6. The illuminator of claim 1, wherein the substrate is bent in an angular U shape.

7. The illuminator of claim 1, wherein the plurality of first LEDs and the plurality of second LEDs each include a red LED, a green LED, and a blue LED.

8. The illuminator of claim 1, wherein the two stories of LEDs consisting of the plurality of first LEDs and the plurality of second LEDs are staggered.

9. The illuminator of claim 1, wherein at least one of a pair of ends of the substrate is disposed so as to overlap an end of the light guide plate.

10. The illuminator of claim 9, wherein both of the pair of ends of the substrate are disposed to overlap an end of the light guide plate, the pair of ends of the substrate sandwiching the light guide plate.

11. The illuminator of claim 1, wherein the light guide plate is of a planar shape having two or more linear portions, and two or more said LED units are provided corresponding respectively to the two or more linear portions.

12. The illuminator of claim 1, wherein the substrate is provided so as to leave at least a portion of the light guide plate uncovered.

13. The illuminator of claim 1, configured to transmit external light from a rear face of the light guide plate.

14. A see-through type display apparatus comprising the illuminator of claim 13 and a transmission-type display panel which is disposed adjacent to the illuminator.

15. A display apparatus comprising: the illuminator of claim 1; a display panel being disposed adjacent to the illuminator; and a bezel being disposed outside of the substrate of the LED unit and having a bent or curved shape, the substrate being entirely in contact with the bezel.
